(19) United States
(12) Patent Application Publication
(10) Pub. No.: US 2006/0281889 A1
(43) Pub. Date: Dec. 14, 2006

(54) Silicone composition for water-repellent coating

(76) Inventors: Hideki Kobayashi, Chiba (JP); Motoshi Sasaki, Chiba (JP)

Correspondence Address: DOW CORNING CORPORATION CO1232, 2200 W. SALZBURG ROAD, P.O. BOX 994, MIDLAND, MI, 48686-0994, US

(21) Appl. No.: 10/478,158

(22) PCT Filed: May 27, 2002
(86) PCT No.: PCT/JP02/05130

§ 371 Date: Aug. 25, 2006

(30) Foreign Application Priority Data
May 30, 2001 (JP) 2001162086

(51) Int. Cl. C08G 77/18; C08G 77/08

(52) U.S. Cl. 528/34; 528/18

(57) ABSTRACT

A silicone composition for a water-repellent coating comprising (A) a polydimethylsiloxane expressed by the general formula:
(RO)₃Si-Q-{(CH₃)₂SiO}ₙ—(CH₃)₂Si-Q-Si(OR)₃,
where R is a C₁ to C₁₀ monovalent hydrocarbon group, Q is an oxygen atom or a C₂ to C₁₀ alkylene group, and n is an integer from 10 to 1000; (B) an alkoxysilane partial hydrolysate/condensate, where the alkoxysilane is described by general formula: R¹ₓSi(OR²)₄₋ₓ, where R¹ is a C₁ to C₆ monovalent hydrocarbon group, R² is a C₁ to C₆ alkyl group, and x is an integer from 0 to 3; (C) an organotitanium-based catalyst; (D) an aliphatic hydrocarbon solvent or ester-based solvent; and (E) an alcohol-based solvent.

The present invention relates to a silicone composition for a water-repellent coating, and more particularly to a silicone composition for a water-repellent coating capable of forming a soft water-repellent film when cured for a short time at a low temperature.

### BACKGROUND ART

In conventional practice, silicone compositions are used as treatment agents that give the surfaces of various substrates water repellency or water resistance. Known examples include silicone resin compositions and compositions primarily containing alkylalkoxysilanes. For example, Japanese Patent Application Publication(Kokai) No.Hei 9-255941 discloses a water repellency treatment agent containing a fluoroalkylsilane. In addition, Japanese Patent Application Publication(Kokai) No.Hei 11-21508 discloses a coating agent composed of a hydrolyzable silicone resin, a phenylsilane, a partial hydrolysate of alkoxysilane, and a tin catalyst. However, such surface treatment agents are disadvantageous in that they have inadequate water repellency and take long to cure, and thus need additional improvement.

Specifically, it is an object of the present invention to provide a silicone composition for a water-repellent coating capable of forming a soft water-repellent film when cured for a short time at a low temperature.

### DISCLOSURE OF INVENTION

A silicone composition for a water-repellent coating comprising

(A) 100 weight parts of a polydimethylsiloxane described by general formula
(RO)₃ Si-Q-{(CH₃)₂SiO}ₙ—(CH₃)₂Si-Q-Si(OR)₃,
where R is a C₁ to C₁₀ monovalent hydrocarbon group, Q is an oxygen atom or a C₂ to C₁₀ alkylene group, and n is an integer from 10 to 1000;
(B) 5 to 100 weight parts of a partial hydrolysate/condensate of alkoxysilane, wherein the alkoxysilane has a general formula
R¹ₓSi(OR²)₄₋ₓ,
where R¹ is a C₁ to C₆ monovalent hydrocarbon group, R² is a C₁ to C₆ alkyl group, and x is an integer from 0 to 3;
(C) 0.1 to 10 weight parts of an organotitanium-based catalyst;
(D) 50 to 900 weight parts of an aliphatic hydrocarbon solvent or ester-based solvent; and
(E) 0.1 to 100 weight parts of an alcohol-based solvent.

The present invention will now be described in detail. The polydimethylsiloxane of component (A) is described by general formula (RO)₃Si-Q-{(CH₃)₂SiO}ₙ—(CH₃)₂Si-Q-Si(OR)₃. In this formula, R is a C₁ to C₁₀ monovalent hydrocarbon group such as methyl, ethyl, propyl, or other alkyl. Of these, methyl and ethyl are preferred. Q is an oxygen atom or a C₂ to C₁₀ alkylene group. Examples of alkylene groups include ethylene, propylene, butylene, and hexylene. In the formula, n is an integer from 10 to 1000, preferably 100 to 800, and ideally 300 to 700. Component (A) can be readily produced by a conventionally known method. When Q in the above general formula is an oxygen atom, the component may, for example, be synthesized by condensing a tetraalkoxysilane and a silanol-blocked polydimethylsiloxane in the presence or absence of a catalyst. The reaction ratio thereof, expressed as the tetraalkoxysilane/silanol group molar ratio, should preferably be 5 to 15. According to another possible method, a trialkoxychlorosilane and a silanol-blocked polydimethylsiloxane are condensed in the presence of a pyridine or other hydrogen halide receptor. When the Q in the above general formula is an alkylene group, the component may be produced by a method in which a trialkoxysilane and an alkenyl-blocked polydimethylsiloxane are hydrosilyated in the presence of a platinum catalyst, or a method in which an alkenyltrialkoxysilane and an SiH-blocked polydimethylsiloxane are hydrosilyated in the presence of a platinum catalyst.

Component (B) is a partial hydrolysate/condensate of alkoxysilane, wherein the alkoxysilane has a general formula R¹ₓSi(OR²)₄₋ₓ. In this formula, R¹ is a C₁ to C₆ monovalent hydrocarbon group such as methyl, ethyl, propyl, or other alkyl group; vinyl, allyl, 5-hexenyl, or other alkenyl group; or phenyl or other aryl group, of which methyl is preferred. R² is a C₁ to C₆ alkyl group such as methyl, ethyl, or propyl, of which methyl and ethyl are preferred. In the formula, x is an integer from 0 to 3, and preferably 1 or 0. Examples of alkoxysilanes suitable for component (B) include dimethyldimethoxysilane, dimethyldiethoxysilane, methyltrimethoxysilane, methyltriethoxysilane, methyltriisopropoxysilane, ethyltrimethoxysilane, ethyltriethoxysilane, tetramethoxysilane, tetraethoxysilane, and tetraisopropoxysilane. These compounds can be used singly or as mixtures of two or more components. Component (B) may be prepared by adding water to such an alkoxysilane to achieve partial hydrolysis/condensation, and the resulting partial hydrolysate/condensate should preferably contain alkoxy groups in an amount at which the OR²/Si ratio falls within a range of 0.8 to 2.6. This is because a ratio greater than 2.6 increases volatility and makes it more likely that the degree of crosslinking will vary, whereas a ratio less than 0.8 reduces compatibility with component (A). The viscosity of component (B) at 25° C. should preferably be 1 to 100 mm²/s. Component (B) should be added in an amount of 5 to 100 weight parts, preferably 5 to 20 weight parts because of considerations related to curability, in each case per 100 weight parts of component (A).

The organotitanium-based catalyst (component (C)) facilitates the hydrolysis and condensation of alkoxy groups. Specific examples of such catalysts include tetramethyl titanate, tetraisopropyl titanate, tetrabutyl titanate, tetra(2-ethylhexyl) titanate, titanium tetraacetyl acetonate, and bis(isopropoxy)titanium bis(acetyl acetonate). Component (C) should be added in an amount of 0.1 to 10 weight parts, preferably 0.5 to 5 weight parts because of considerations related to curability, in each case per 100 weight parts of component (A).

The aliphatic hydrocarbon solvent or ester-based solvent (component (D)) is a component that dissolves component (A) or (B) and improves the applicability of the present composition. Specific examples of suitable aliphatic hydrocarbon solvents include hexane, octane, heptane, n-paraffins (such as Normal Paraffin SL, L, and M® from Nippon Petrochemicals), and other linear aliphatic hydrocarbons, and isohexane, isoparaffins (such as Isosol 200 and 300® from Nippon Petrochemicals), and other branched aliphatic hydrocarbons. Specific examples of suitable ester-based solvents include ethyl acetate, butyl acetate, and isobutyl acetate. Component (D) should be added in an amount of 50 to 900 weight parts, preferably 100 to 500 weight parts because of considerations related to the ease of application, in each case per 100 weight parts of component (A).

The alcohol-based solvent (component (E)) is a diluting component designed to improve the dispersibility of component (C) and storage stability of the present composition. Specific examples include methanol, ethanol, isopropanol, butanol, and isobutanol. These alcohol-based solvents may also contain small amounts of moisture. Component (E) should be added in an amount of 0.1 to 100 weight parts, and preferably 0.5 to 50 weight parts, in each case per 100 weight parts of component (A). This is because adding less than 0.1 weight part has an adverse effect on the dispersion stability of component (C), whereas adding more than 100 weight parts has an adverse effect on applicability.

Although the composition of the present invention comprises the above-described components (A) to (E), it is also possible to optionally add coloring pigments, anticorrosive pigments, and other pigments; antimicrobial agents; polyether-modified silicones and other leveling agents; antifouling agents; and the like in an appropriate manner. The following components may also be added in an appropriate manner in order to improve the adhesion of the resulting coating film: 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, 3-(2-aminoethyl)aminopropylmethyldimethoxysilane, 3-(2-aminoethyl)aminopropylmethyldiethoxysilane, and other aminosilane coupling agents; and 3-glycidoxypropyltrimethoxysilane. 3-glycidoxypropylmethyldimethoxysilane, and other epoxysilane coupling agents; as well as 3-mercaptopropyltrimethoxysilane, 3-methacryloxypropyltrimethoxysilane, and the like. It should be noted, however, that the present composition does not contain any alkoxysilanes that have phenyl groups.

The present composition may, for example, be applied by dipping, spraying, or brushing. The coating film may have any thickness, but a thickness of 1 to 500 μm is preferred. Although it is common knowledge that a film with excellent water repellency can be formed by applying a material and heating it, the composition of the present invention is characterized in that fast curing can be achieved even at comparatively low heating temperatures (50 to 100° C.). For example, a cured film can be formed in 0.5 to 20 minutes when the material is heated to 100° C., and in 1 to 30 minutes when the material is heated to 80° C. Additional benefits include the fact that the present composition has excellent storage stability and can form a film that exhibits excellent water repellency at a low temperature in a short time even after prolonged standing. The composition is therefore suitable as a water-repellent coating for acrylic resins, ABS resins, polyester nonwovens, leather, synthetic imitation leather, and other organic materials. Glass, iron, aluminum, and stainless steel plates can also be cited as examples of substrates to which the present composition can be applied. Since a cured film commonly has a pencil hardness of 6B or less, the composition of the present invention can be used as a water-repellent agent for forming coatings on materials for which such soft films are required, such as wallpaper, ceiling finishes, flooring materials, cloth, curtains, and other materials for interior use; doors, roofs, seats, and other interior materials of automobile or vehicle; and films, sheets, and other packaging materials.

### BEST MODE FOR CARRYING OUT THE INVENTION

The present invention will now be described through working and comparative examples. In the working examples, “parts” refers to weight parts, “viscosity” denotes values measured at 25° C., and “Me” refers to methyl group. In addition, the contact angle of the film with water was measured using a contact angle meter (CA-Z® from Kyowa Interface Science), and the pencil hardness was measured by the method defined in JIS K5400.

### Synthesis Example

Hydrochloric acid (1/100 N, 115 g) was added in drops while methyltrimethoxysilane (775 g) and methanol (110 g) were stirred. Following the dropwise addition, the system was heated and stirred under reflux for 7 hours. Stripping was then performed at a reduced pressure and the product was cooled and filtered, yielding 490 g of a partial hydrolysate/condensate of methyltrimethoxysilane(B1) with a viscosity of 25 mm²/s. It was determined by ¹³C-NMR analysis that the resulting partial hydrolysate/condensate had a methoxy residue/Si ratio of 0.9.

### Working Example 1

The following components were added to 100 parts of a polydimethylsiloxane fluid that had a viscosity of about 3000 mPa·s and was described by the average molecular formula (MeO)₃SiO(Me₂SiO)₃₀₀Si(OMe)₃: 20 parts of the partial hydrolysate/condensate of methyltrimethoxysilane(B1) obtained as the synthetic example, 390 parts of an isoparaffin solvent (Isosol 300® from Nippon Petrochemicals), 10 parts of isopropyl alcohol, and 3 parts of bis(isopropoxy)titanium bis(acetyl acetonate), yielding a light-yellow transparent silicone composition for coating.

The resulting silicone composition was applied to a polyester nonwoven for wallpaper and heat-treated for 5 minutes in a 100° C. oven, yielding a cured film. The contact angle of the film with water was 106° and the pencil hardness thereof was 6B or less. The silicone composition was stored for 3 months at room temperature, and a cured film was formed on the surface of a polyester nonwoven for wallpaper in the same manner. The contact angle of the film with water was measured and it was found that the result was the same as that obtained immediately after preparation. In addition, no change was detected in product appearance.

### Working Example 2

The following components were added to 100 parts of a polydimethylsiloxane fluid that had a viscosity of about 3000 mPa·s and was described by the average molecular formula (MeO)₃SiO(Me₂SiO)₃₀₀Si(OMe)₃: 20 parts of a partial hydrolysate/condensate of tetraethoxysilane(Ethyl Silicate 40® from Tama Chemicals) with a viscosity of 5 mm²/s and an ethoxy residue/Si ratio of 2.2, 390 parts of an isoparaffin solvent (Isosol 300® from Nippon Petrochemicals), 10 parts of isopropyl alcohol, and 3 parts of bis(isopropoxy)titanium bis(acetyl acetonate), yielding a silicone composition for coating.

The resulting silicone composition was applied to a polyester nonwoven for wallpaper and heat-treated for 5 minutes in a 100° C. oven, yielding a cured film. The contact angle of the film with water was 105° and the pencil hardness thereof was 6B or less.

### Comparative Example 1

A silicone composition for coating was prepared in the same manner as in Working Example 2 except that the bis(isopropoxy)titanium bis(acetyl acetonate) (3 parts) used in Working Example 2 was dispensed with.

The resulting silicone composition was applied to a polyester nonwoven for wallpaper and heat-treated for 5 minutes in a 100° C. oven, yielding a film. The contact angle of the film with water was measured and it was found that water had penetrated into the polyester nonwoven and that the film had failed to become water repellent.

### Working Example 3

The following components were added to 100 parts of a polydimethylsiloxane fluid that had a viscosity of about 3000 mPa·s and was described by the average molecular formula (MeO)₃SiO(Me₂SiO)₃₀₀Si(OMe)₃: 20 parts of a partial hydrolysate/condensate of methyltrimethoxysilane(MS51® from Mitsubishi Chemical) with a viscosity of 5 mm²/s and an methoxy residue/Si ratio of 2.5, 390 parts of an isoparaffin solvent (Isosol 300® from Nippon Petrochemicals), 10 parts of isopropyl alcohol, and 3 parts of bis(isopropoxy)titanium bis(acetyl acetonate), yielding a silicone composition for coating.

The resulting silicone composition was applied to a polyester nonwoven for wallpaper and heat-treated for 5 minutes in a 100° C. oven, yielding a cured film. The contact angle of the film with water was 106° and the pencil hardness thereof was 6B or less.

### Working Example 4

The following components were added to 100 parts of a polydimethylsiloxane fluid that had a viscosity of about 3000 mPa·s and was described by the average molecular formula (MeO)₃ Si—C₂H₄-(Me₂SiO)₃₀₀Me₂Si—C₂H₄—Si(OMe)₃: 20 parts of the partial hydrolysate/condensate of methyltrimethoxysilane(B 1) obtained as the synthetic example, 390 parts of an isoparaffin solvent (Isosol 200® from Nippon Petrochemicals), 10 parts of isopropyl alcohol, and 3 parts of bis(isopropoxy)titanium bis(acetyl acetonate), yielding a silicone composition for coating.

The resulting silicone composition was applied to a polyester nonwoven for wallpaper and heat-treated for 5 minutes in a 100° C. oven, yielding a cured film. The contact angle of the film with water was 106° and the pencil hardness thereof was 6B or less.

### Working Example 5

The following components were added to 100 parts of a polydimethylsiloxane fluid that had a viscosity of about 3000 mPa·s and was described by the average molecular formula (MeO)₃SiO(Me₂SiO)₃₀₀Si(OMe)₃: 20 parts of the partial hydrolysate/condensate of methyltrimethoxysilane(B1) obtained as the synthetic example, 390 parts of ethyl acetate, 10 parts of isopropyl alcohol, and 3 parts of bis(isopropoxy)titanium bis(acetyl acetonate), yielding a silicone composition for coating.

The resulting silicone composition was applied to a polyester nonwoven for wallpaper and heat-treated for 10 minutes in a 80° C. oven, yielding a cured film. The contact angle of the film with water was 105° and the pencil hardness thereof was 6B or less.

### Comparative Example 2

The following components were added to 100 parts of a polydimethylsiloxane fluid that had a viscosity of about 3000 mPa·s and was described by the average molecular formula (MeO)₃SiO(Me₂SiO)₃₀₀Si(OMe)₃: 20 parts of the partial hydrolysate/condensate of methyltrimethoxysilane(B 1) obtained as the synthetic example, 400 parts of isopropyl alcohol, and 3 parts of bis(isopropoxy)titanium bis(acetyl acetonate), yielding a silicone composition for coating.

The resulting silicone composition was applied to a polyester nonwoven for wallpaper and heat-treated for 5 minutes in a 100° C. oven, yielding a cured film. The contact angle of the film with water was 106°. The silicone composition was stored for 3 months at room temperature, a cured film was formed on the surface of a polyester nonwoven for wallpaper in the same manner and the contact angle of the film with water was measured and found to have decreased to 100°. It was thus demonstrated that the silicone composition had inadequate storage stability.

### Comparative Example 3

The following components were added to 100 parts of a polydimethylsiloxane fluid that had a viscosity of about 3000 mPa·s and was described by the average molecular formula (MeO)₃SiO(Me₂SiO)₃₀₀Si(OMe)₃: 20 parts of the partial hydrolysate/condensate of methyltrimethoxysilane(B 1) obtained as the synthetic example, 400 parts of an isoparaffin solvent (Isosol 300® from Nippon Petrochemicals), and 3 parts of bis(isopropoxy)titanium bis(acetyl acetonate), yielding a light-yellow transparent silicone composition for coating.

The silicone composition was stored at room temperature, and cloudiness was observed in two months. It was thus demonstrated that the silicone composition had inadequate storage stability.

### Comparative Example 4

The following components were added to 100 parts of a polydimethylsiloxane fluid that had a viscosity of about 3000 mPa·s and was described by the average molecular formula (MeO)₃SiO(Me₂SiO)₃₀₀Si(OMe)₃: 20 parts of the partial hydrolysate/condensate of methyltrimethoxysilane(B 1) obtained as the synthetic example, 390 parts of an isoparaffin solvent (Isosol 300® from Nippon Petrochemicals), 10 parts of isopropyl alcohol, and 3 parts of dibutyltin dilaurate, yielding a silicone composition for coating.

The resulting silicone composition was applied to a polyester nonwoven for wallpaper and heat-treated for 5 minutes in a 100° C. oven, yielding a cured film. The contact angle of the film with water was measured and found to be 100°, indicating that the film had inadequate water repellency.

### INDUSTRIAL APPLICABILITY

Because the present silicone composition as described above is capable of forming a soft water-repellent film when cured for a short time at a low temperature, it is suitable as a water-repellent coating for acrylic resins, ABS resins, polyester nonwovens, leather, synthetic imitation leather, and other organic materials; and it can be used as a water-repellent agent for forming coatings on materials such as wallpaper, ceiling finishes, flooring materials, cloth, curtains, and other materials for interior use; doors, roofs, seats, and other interior materials of automobile or vehicle, and films, sheets, and other packaging materials.

1. A silicone composition for a water-repellent coating comprising
(A) 100 weight parts of a polydimethylsiloxane described by general formula
(RO)₃ Si-Q-{(CH₃)₂SiO}ₙ—(CH₃)₂Si-Q-Si(OR)₃,
wherein R is a C₁ to C₁₀ monovalent hydrocarbon group, each Q is independently selected from the group consisting of an oxygen atom and a C₂ to C₁₀ alkylene group, and n is an integer from 10 to 1000;
(B) 5 to 100 weight parts of a material selected from the group consisting of (i) a partial hydrolysate of alkoxysilane (ii) a condensate of (i), wherein the alkoxysilane has a general formula
R¹ₓSi(OR²)₄₋ₓ,
wherein R¹ is a C₁ to C₆ monovalent hydrocarbon group, R² is a C₁ to C₆ alkyl group, and x is an integer from 0 to 3;
(C) 0.1 to 10 weight parts of an organotitanium-based catalyst;
(D) 50 to 900 weight parts of a solvent selected from the group consisting of (i) aliphatic hydrocarbon solvent and (ii) an ester-based solvent; and
(E) 0.1 to 100 weight parts of an alcohol-based solvent.

2. The silicone composition as claimed in claim 1, wherein the content of alkoxy groups in component (B), expressed as the OR²/Si ratio, is 0.8 to 2.6.

3. The silicone composition as claimed in claim 1, wherein R¹ is the methyl radical, R² is selected from the group consisting of methyl radicals and ethyl radicals, and x is 1 or 0.

4. The silicone composition as claimed in claim 2, wherein R¹ is the methyl radical, R² is selected from the group consisting of methyl radicals and ethyl radicals, and x is 1 or 0.

5. The silicone composition as claimed in claim 1, wherein n is an integer from 100 to 800.

6. The silicone composition as claimed in claim 2, wherein n is an integer from 100 to 800.

7. The silicone composition as claimed in claim 1, wherein component (B) has a viscosity at 25° C. of 1 to 100 mm²/s.

8. The silicone composition as claimed in claim 2, wherein component (B) has a viscosity at 25° C. of 1 to 100 mm²/s.

9. The silicone composition as claimed in claim claim 1, comprising 5 to 20 weight parts of component (B) per 100 weight parts of component (A).

10. The silicone composition as claimed in claim 2, comprising 5 to 20 weight parts of component (B) per 100 weight parts of component (A).

11. The silicone composition as claimed in claim 1, comprising 100 to 500 weight parts of component (D) per 100 weight parts of component (A).

12. The silicone composition as claimed in claim 2, comprising 100 to 500 weight parts of component (D) per 100 weight parts of component (A).

13. The silicone composition as claimed in claim 1, comprising 0.5 to 50 weight parts of component (E) per 100 weight parts of component (A).

14. The silicone composition as claimed in claim 2, comprising 0.5 to 50 weight parts of component (E) per 100 weight parts of component (A).

15. A silicone composition for a water-repellant coating comprising
(A) 100 weight parts of a polydimethylsiloxane described by the general formula
(RO)₃Si-Q-{(CH₃)₂SiO}ₙ—(CH₃)₂Si-Q-Si(OR)₃,
where R is a C₁ to C₁₀ monovalent hydrocarbon group, Q is independently selected from the group consisting of (i) an oxygen atom and (ii) a C₂ to C₁₀ alkylene group, and n is an integer from 100 to 800;
(B) 5 to 20 weight parts of a material selected from the group consisting of (i) a partial hydrolysate of alkoxysilanes and (ii) a condensate (i), wherein the alkoxysilane has the general formula
R¹ₓSi(OR²)₄₋ₓ,
where R¹ is a methyl radical, R² is selected from the group consisting of methyl radicals and ethyl radicals, x is 1 or 0, and the ratio of OR²/Si is 0.8 to 2.6;
(C) 0.1 to 10 weight parts of an organotitanium-based catalyst;
(D) 100 to 500 weight parts of a solvent selected from the group consisting of (i) an aliphatic hydrocarbon solvent and (ii) an ester-based solvent; and
(E) 0.5 to 50 weight parts of an alcohol-based solvent.

16. An organic material coated with the composition of claim 1.

17. An organic material coated with the composition of claim 2.

18. An organic material coated with the composition of claim 15.
